(19) United States
(12) Patent Application Publication
(10) Pub. No.: US 2026/0051949 A1
(43) Pub. Date: Feb. 19, 2026

(54) EXTENDED BAND TWO-FOLDED ORTHOGONAL MODE MICROWAVE TRANSDUCER DEVICES AND METHODS

(71) Applicants: MAHMOUD GADELRAB AHMED GADELRAB, VERDUN (CA); SHOKRY IBRAHIM ABDELRAZAK SHAMSELDIN, EDMONTON (CA); MAHMOUD ELSAADANY, EDMONTON (CA); ABDELRAZIK SEBAK, BROSSARD (CA)

(72) Inventors: MAHMOUD GADELRAB AHMED GADELRAB, VERDUN (CA); SHOKRY IBRAHIM ABDELRAZAK SHAMSELDIN, EDMONTON (CA); MAHMOUD ELSAADANY, EDMONTON (CA); ABDELRAZIK SEBAK, BROSSARD (CA)

(21) Appl. No.: 19/303,042

(22) Filed: Aug. 18, 2025

Related U.S. Application Data
(60) Provisional application No. 63/684,665, filed on Aug. 19, 2024.

(51) Int. Cl. H04B 7/185

(52) U.S. Cl. CPC H04B 7/18515

(57) ABSTRACT

Satellite networks play an important role in many applications due to their unique features of global coverage and mobility assistance. Low Earth Orbit (LEO) satellites are currently gaining popularity in wireless communications as they will be heavily used in future wireless communication networks. To enable polarisation diversity, satellite systems commonly use dual-polarized antennas where orthomode transducers (OMTs) are employed in such systems to feed the antennas with the two orthogonal polarizations. An OMT should provide high impedance matching, high isolation levels between ports as well as being lightweight and compact. OMT designs are presented providing a bandwidth ratio of about 55% with good impedance matching and high isolation compatible with LEO satellite feeding structures in terms of thermal, power, and passive intermodulation analysis.

### CROSS-REFERENCE TO RELATED APPLICATIONS

This patent application claims the benefit of priority to U.S. Provisional Patent Application 63/684,665 filed Aug. 19, 2024; the entire contents of which are incorporated herein by reference.

### FIELD OF THE INVENTION

This patent application relates to orthogonal mode transducers for satellites and more particularly to designs and design methodologies for orthogonal mode transducers for low earth orbit satellites.

### BACKGROUND OF THE INVENTION

Satellite networks play an important role in many applications due to their unique features of global coverage and mobility assistance. Low Earth Orbit (LEO) satellites are currently gaining popularity in wireless communications as they will be heavily used in future wireless communication networks. To enable polarisation diversity, satellite systems commonly use dual-polarized antennas where orthomode transducers (OMTs) are employed in such systems to feed the antennas with the two orthogonal polarizations.

Accordingly, an OMT should provide high impedance matching, high isolation levels between ports as well as being lightweight and compact. The inventors present OMT designs providing a bandwidth ratio of about 55% with good impedance matching and high isolation compatible with LEO satellite feeding structures in terms of thermal, power, and passive intermodulation analysis.

Other aspects and features of the present invention will become apparent to those ordinarily skilled in the art upon review of the following description of specific embodiments of the invention in conjunction with the accompanying figures.

### SUMMARY OF THE INVENTION

It is an object of the present invention to mitigate limitations within the prior art relating to orthogonal mode transducers for satellites and more particularly to designs and design methodologies for orthogonal mode transducers for low earth orbit satellites.

In accordance with an embodiment of the invention there is provided a device comprising:
a first element comprising an input port, a junction and four output ports in a plane wherein a microwave signal within a predetermined frequency range coupled to the input port is split into a first polarisation which is coupled to a first pair of the four output ports which are disposed on either side of junction along a first axis and a second polarisation which is coupled to a second pair of the four output ports which are disposed on either side of junction along a second axis where the first axis is orthogonal to the second axis;
a first arm of a combining network comprising;
   a first combiner comprising a pair of first ports coupled to one of the first pair of the four output ports and the second pair of the four output ports and a second port coupled to the pair of first ports;
   a waveguide twist coupled at one end to the second port of the first combiner and at a second distal end to a first offset waveguide; and
   the first offset waveguide; and
a second arm of the combining network comprising:
   a second combiner comprising another pair of first ports coupled to the other of the first pair of the four output ports and the second pair of the four output ports and another second port coupled to the pair of first ports where the each first port of the another pair of first ports is coupled to an output port of the other of the first pair of the four output ports and the second pair of four output ports by a second offset waveguide;
   the two second offset waveguides; and
   another waveguide twist coupled at one end to the another second port of the second combiner and at a second distal end of the another waveguide twist to an end of a waveguide.

In accordance with an embodiment of the invention there is provided a method comprising:
a first element comprising an input port, a junction and four output ports in a plane wherein a microwave signal within a predetermined frequency range coupled to the input port is split into a first polarisation which is coupled to a first pair of the four output ports which are disposed on either side of junction along a first axis and a second polarisation which is coupled to a second pair of the four output ports which are disposed on either side of junction along a second axis where the first axis is orthogonal to the second axis;
a first arm of a combining network comprising;
   a first combiner comprising a pair of first ports coupled to one of the first pair of the four output ports and the second pair of the four output ports and a second port coupled to the pair of first ports;
   a waveguide twist coupled at one end to the second port of the first combiner and at a second distal end to a first offset waveguide; and
   the first offset waveguide; and
a second arm of the combining network comprising:
   a second combiner comprising another pair of first ports coupled to the other of the first pair of the four output ports and the second pair of the four output ports and another second port coupled to the pair of first ports where the each first port of the another pair of first ports is coupled to an output port of the other of the first pair of the four output ports and the second pair of four output ports by a second offset waveguide;
   the two second offset waveguides; and
   another waveguide twist coupled at one end to the another second port of the second combiner and at a second distal end of the another waveguide twist to an end of a waveguide.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

Embodiments of the present invention will now be described, by way of example only, with reference to the attached Figures, wherein:

FIG. 1A depicts schematically an internal structure of an OMT according to an embodiment of the invention;

FIG. 1B depicts the design of the stepped cylinders of the turnstile junction within an OMT according to an embodiment of the invention;

FIG. 1C depicts S-parameters for the turnstile junction forming part of an OMT according to the embodiment of the invention depicted in FIGS. 1A and 1B respectively;

FIGS. 2A-2C depicts the designs of an H-offset, twists and E-splitter/combiner for a main section of an OMT according to an embodiment of the invention;

FIG. 2D depicts S-parameters of the main section of an OMT according to the embodiment of the invention as depicted in FIGS. 2A-2C respectively;

FIGS. 3A and 3B depicts the design of a first arm and second arm of a combining network of an OMT according to an embodiment of the invention;

FIG. 3C depicts S-parameters of the main section of the combining network of an OMT according to the embodiment of the invention as depicted in FIGS. 3A and 3B respectively;

FIGS. 4A and 4B depicts V-mode and H-mode lines of an OMT according to an embodiment of the invention;

FIG. 4C depicts S-parameters of the OMT according to the embodiment of the invention as depicted in FIGS. 4A and 4B respectively;

FIG. 5A depicts a three-dimensional (3D) model of an overall structure of an OMT according to an embodiment of the invention;

FIGS. 5B and 5C depict three-dimensional (3D) modelling of a proposed cut for the splitter and the main section of OMT according to an embodiment of the invention depicted in FIG. 5A;

FIGS. 6A to 6C depict multipaction analysis for V-mode, H-mode and corona analysis of the OMT according to an embodiment of the invention as depicted in FIG. 5A;

FIG. 7 depicts S-parameters of an OMT according to an embodiment of the invention at 130° C. and −65° C. for an input power of 500 W;

FIGS. 8A to 8C depict pressure analysis of an OMT according to an embodiment of the invention for the overall structure and a pair of internal cuts (sections 5 and 7) depicted in FIG. 5;

FIGS. 9A to 9C depict fabricated parts for testing an OMT according to an embodiment of the invention together with text measurement configurations for single unit evaluation and back-to-back evaluation respectively; and

FIG. 10 depicts measured and simulated S-parameters for an OMT according to an embodiment of the invention.

### DETAILED DESCRIPTION

The present invention is directed to orthogonal mode transducers for satellites and more particularly to designs and design methodologies for orthogonal mode transducers for low earth orbit satellites.

The ensuing description provides representative embodiment(s) only, and is not intended to limit the scope, applicability or configuration of the disclosure. Rather, the ensuing description of the embodiment(s) will provide those skilled in the art with an enabling description for implementing an embodiment or embodiments of the invention. It being understood that various changes can be made in the function and arrangement of elements without departing from the spirit and scope as set forth in the appended claims. Accordingly, an embodiment is an example or implementation of the inventions and not the sole implementation. Various appearances of “one embodiment,” “an embodiment” or “some embodiments” do not necessarily all refer to the same embodiments. Although various features of the invention may be described in the context of a single embodiment, the features may also be provided separately or in any suitable combination. Conversely, although the invention may be described herein in the context of separate embodiments for clarity, the invention can also be implemented in a single embodiment or any combination of embodiments.

Reference in the specification to “one embodiment”, “an embodiment”, “some embodiments” or “other embodiments” means that a particular feature, structure, or characteristic described in connection with the embodiments is included in at least one embodiment, but not necessarily all embodiments, of the inventions. The phraseology and terminology employed herein is not to be construed as limiting but is for descriptive purpose only. It is to be understood that where the claims or specification refer to “a” or “an” element, such reference is not to be construed as there being only one of that element. It is to be understood that where the specification states that a component feature, structure, or characteristic “may”, “might”, “can” or “could” be included, that particular component, feature, structure, or characteristic is not required to be included.

Reference to terms such as “left”, “right”, “top”, “bottom”, “front” and “back” are intended for use in respect to the orientation of the particular feature, structure, or element within the figures depicting embodiments of the invention. It would be evident that such directional terminology with respect to the actual use of a device has no specific meaning as the device can be employed in a multiplicity of orientations by the user or users.

Reference to terms “including”, “comprising”, “consisting” and grammatical variants thereof do not preclude the addition of one or more components, features, steps, integers or groups thereof and that the terms are not to be construed as specifying components, features, steps or integers. Likewise, the phrase “consisting essentially of”, and grammatical variants thereof, when used herein is not to be construed as excluding additional components, steps, features integers or groups thereof but rather that the additional features, integers, steps, components or groups thereof do not materially alter the basic and novel characteristics of the claimed composition, device or method. If the specification or claims refer to “an additional” element, that does not preclude there being more than one of the additional element.

Satellite networks and mobile communication systems arc rapidly expanding, driving the need for enhanced channel bandwidth efficiency. Applications such as circularly polarized antennas and beam scanning antenna systems are gaining prominence in various frequency bands. Several corporations are competing for a share of the satellite Internet market, with plans to deploy a huge number of small satellites in Low-Earth Orbit (LEO) to meet the demands of future applications and services. This market is projected to reach US$4.36 billion in 2025, with a compound annual growth rate of approximately 17%. The attractiveness of LEO satellites stems from their shorter round-trip time compared to Geostationary Orbit (GEO) satellites. Moreover, the position of LEO satellites offers several advantages such as lower losses, reduced round-trip delays, and the ability to utilize smaller satellites with lower power requirements. The continuous growth of space communication demands improved channel bandwidth efficiency, often achieved through the utilization of dual orthogonal polarizations to enhance channel capacity. As a result. orthomode transducers (OMTs) have therefore become an important component, particularly in antenna feeding systems for space applications. The OMT plays a crucial role in transmitting and/or receiving two orthogonal polarizations using a standardized physical structure.

An OMT is a three-port passive device with a common port and two single-mode ports. The common port carries the two degenerate orthogonal modes, whereas each of the other two ports is coupled to one of the common port's degenerate modes. Waveguide-based OMTs arc classified into three types based on their configuration: one-fold symmetric, twofold symmetric and asymmetric. The asymmetric OMT has the simplest and most compact structure and provides orthogonal mode splitting. The generation of the first higher modes (TE11/TM11) due to the asymmetry results in a limited bandwidth, theoretically 20%. However, the first two symmetry types have high isolation between orthogonal channels and a wide operating bandwidth, which is achieved at the expense of increased mechanical complexity and size. The Bøifot junctions within one-fold symmetric OMT structures require the use of a power divider for one of the polarization ports. The twofold symmetric OMTs with the turnstile junction is the most complicated configuration but offers the widest operating bandwidth. The in-band higher-order mode excitation is overcome within this OMT design such that it can offer a wide bandwidth of 25%-40% with a high isolation level of approximately 50 dB.

For a symmetric OMT, the main arms and side arms are divided into two symmetrical sections. Moreover. the junction and routing combiners play a major role in achieving a wide band of operation. Within the prior art the majority of routing combiners utilized are matched waveguide tees or multi-stepped Y-shape power combiners. Recently, some designs have been proposed based on what is referred to as a half-height topology, where the four waveguides of the main section are combined using a full-height to half-height combiner which results in improved bandwidth performance. However, all published twofold symmetry OMT designs are large whereas LEO and other satellite applications would benefit from more compact designs. Further, the output port orientation in these prior art designs is either not aligned in the same plane or does not have the same orientation. Further, none of the prior art designs presented have addressed the thermal or gas breakdown analysis for the OMT structure, which is essential for satellite application systems.

Accordingly, the inventors have established designs and design methodologies for compact twofold OMTs. Whilst the embodiments of the invention are presented with respect to designs operating within the Ka-band (17.7-31 GHZ) it would be evident that compact twofold OMTs exploiting the design methodologies may be designed and implemented for other microwave bands as well as microwave frequency ranges overlapping a portion of the Ka-band.

The presented embodiment of the invention offers a wide bandwidth of approximately 55% whilst having a matching level of 20 dB, an insertion loss is 0.25 dB, and an isolation of −50 dB. The compact size of the OMT according to embodiments of the invention is approximately 4λ₀×2.2λ₀×5.3λ₀ where λ₀ is the wavelength of the center frequency of operation of the OMT. The inventors further show that OMT's according to embodiments of the invention meet the requirements for compatibility with LEO satellite feeding structures with respect to thermal, power, and passive intermodulation performance requirements.

### 1. Orthomode Transducer Design

The inventive twofold OMT structure consists of two primary components, a main section and a combining network. Within the following description these are specifically designed and optimized for operation in the Ka-band, covering a frequency range of 17.7 GHZ to 31 GHz. However, the design methodology of the inventive compact twofold OMT supports designs for operation within other microwave bands as well as microwave frequency ranges overlapping a portion of the Ka-band.

The inventors present an innovative design concept for the combining network thereby enabling the ports to be aligned in the same orientation on a single plane. Moreover, the overall assembly of the structure deploys innovative cutting planes, which will be further discussed below.

### 1A. Main Section

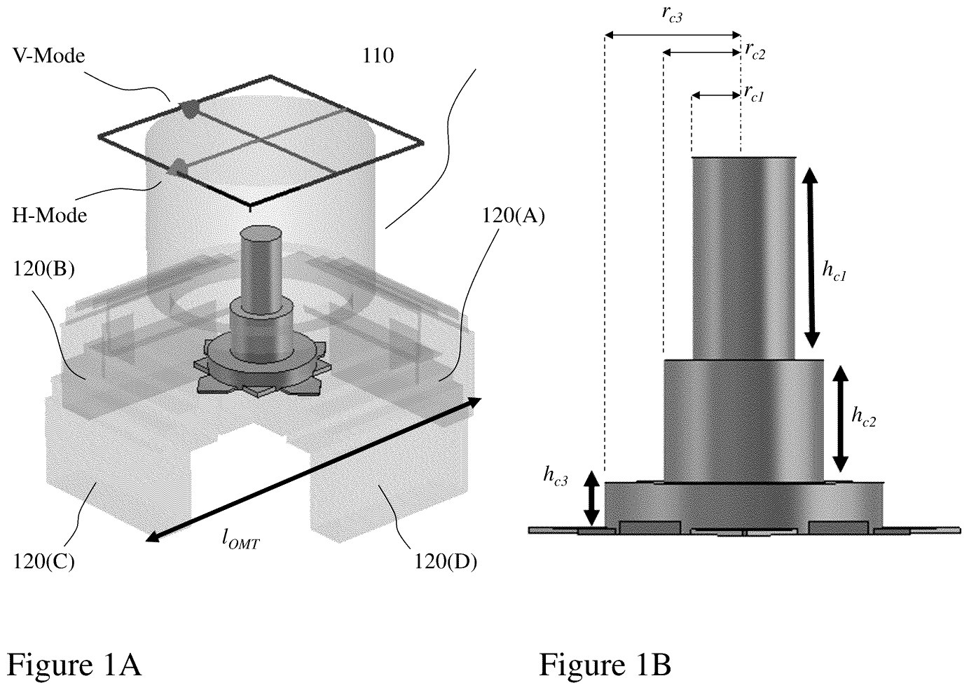

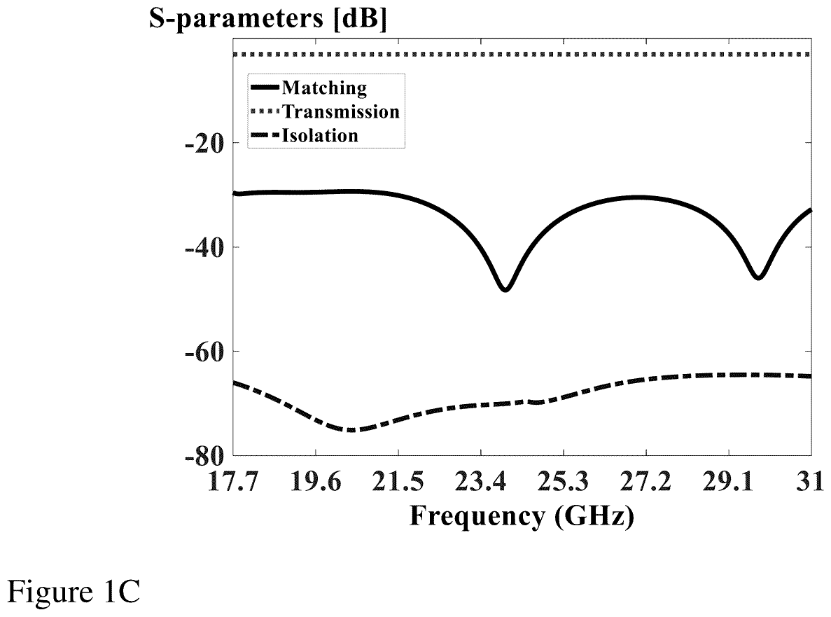

The main section of the OMT is turnstile junction polarizer which functions to separate an incident wave into two main polarizations. These vertical and horizontal modes are separated equally between the two opposite ports from the input port. Within embodiments of the design the junction polarizer is composed of three stepped cylinders as depicted in FIGS. 1A and 1B respectively. As depicted in FIG. 1B the turnstile junction polarizer is depicted as comprising three-sections with of lengths h_{c1}, h_{c2}, and h_{c3} and radii r_{c1}, T_{c1}, and r_{c1}. The dimensions for the Ka-band turnstile junction polarizer described and depicted below are presented within Table 1. The overall length of the junction, as depicted in FIG. 1A being 23 mm (˜0.9″).

TABLE 1
Cylinder Dimensions of Turnstile Junction

| Parameter | Value | Parameter | Value |
|---|---|---|---|
| r_{c1} | 1.107 mm (~0.0435″) | h_{c1} | 4.318 mm (~0.170″) |
| r_{c2} | 1.717 mm (~0.0675″) | h_{c2} | 2.616 mm (~0.103″) |
| r_{c3} | 2.988 mm (~0.118″) | h_{c3} | 0.972 mm (~0.038″) |

The inventors note that the impedance bandwidth of a turnstile junction polarizer can be expanded by increasing the number of steps in the multi-stepped cylindrical scattering element depicted in FIG. 1B. However, a larger number of steps results in a larger volume for the turnstile OMT. Additionally, as the number of steps increases, the top metallic cylinder tends to become thinner, which can lead to significant mechanical challenges, particularly at millimeter-wave frequencies and above.

The inventors note that they have integrated tapered ridges [should clarify where these are etc. and perhaps cross-section to show tapers as unclear from current images] within the design of the turnstile junction polarizer to widen the operating bandwidth wherein the designs according to embodiments of the invention achieve approximately 54.6% bandwidth. Additionally, the inventors employ a circular waveguide as the Main Port 110 to carry the two orthogonal linear polarized modes as shown in FIG. 1A.

The four Planar Ports 120A-120D (at the four sides of the lower portion of the OMT main section depicted in FIG. 1A) are non-standard half-height rectangular waveguides with dimensions 9.14×4.57 mm (˜0.36″×0.18″) with a cutoff frequency of 16.4 GHz. The common Main Port 110 was chosen to be a circular waveguide with a radius 5.715 mm (˜0.225″) which supports both TE11 modes, referred to as V-mode and H-mode. It would be evident to one of skill that some higher-order odd modes will be within the employed bandwidth. However, these modes are not excited due to the design symmetry. The response for this main section, turnstile junction polarizer depicted in FIGS. 1A and 1B, is presented in FIG. 1C where it is evident that the design supports a wide band of operation with a 30 dB matching level. Furthermore, the simulated results indicate that high isolation has been achieved between two input waves with two orthogonal directions, >60 dB.

### 1B. Combining Elements

The main section consists of five ports: a common circular waveguide port (Main Port 110) and four rectangular waveguide ports (first to fourth Ports 120A to 120D respectively). Within the inventive twofold OMT designs, two Y-shaped junctions are used to combine the signals from the four rectangular waveguide ports (first to fourth Ports 120A to 120D respectively). The separated waves from the turnstile junction polarizer are directed through 180° E-plane two-step bends, and the power is combined through the Y-shaped junctions.

Whilst this technique has been employed within the prior art the resulting output ports from this combining network either lack alignment in the same plane or do not possess the same orientation. Moreover, this network design is phase sensitive and this is one of the parameters that should be taken into consideration when designing the combining network since it is a three-port network. This results in the overall dimensions of the OMT with this combining network being large.

In order to address this the inventors proposed and have established a novel combining network that is composed of an H-offset, an E-splitter, and twists. The first two ports are connected to a half-height to full-height E-splitter/combiner, followed by a 90° twist and an H-offset at the end. The remaining two ports are connected to the same components but with a different arrangement. Initially, they are linked to a half-height H-offset then an E-splitter/combiner and a 0° twist. The inclusion of the twists ensures that the output ports have same orientation. Further, the zero-degree twist compensates for the phase difference introduced by the other twist in the first combining network. A benefit of this design is the flexibility of the H-offset, allowing the distance between the two ports to be adjusted based on waveguide flanges or specific design requirements.

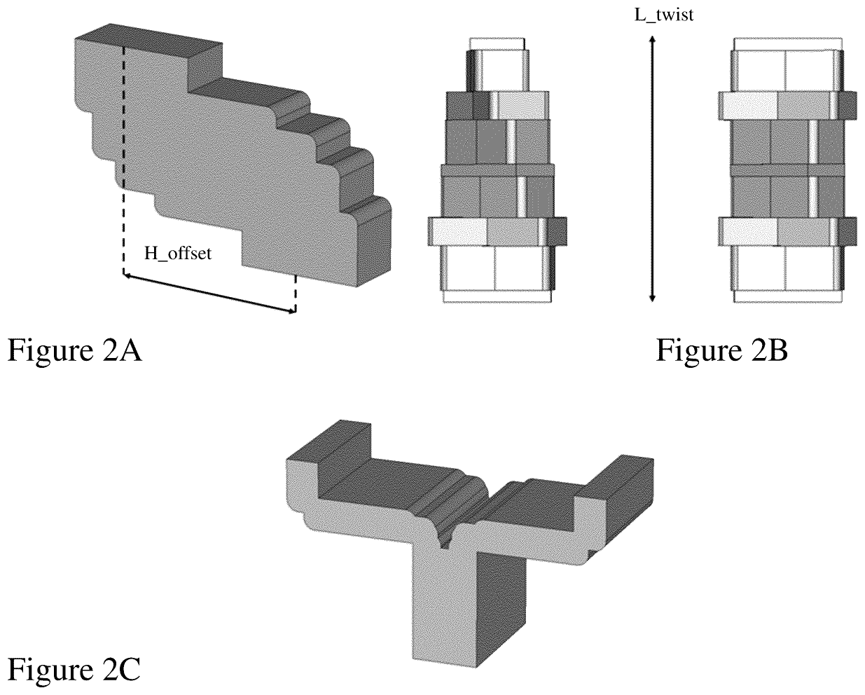

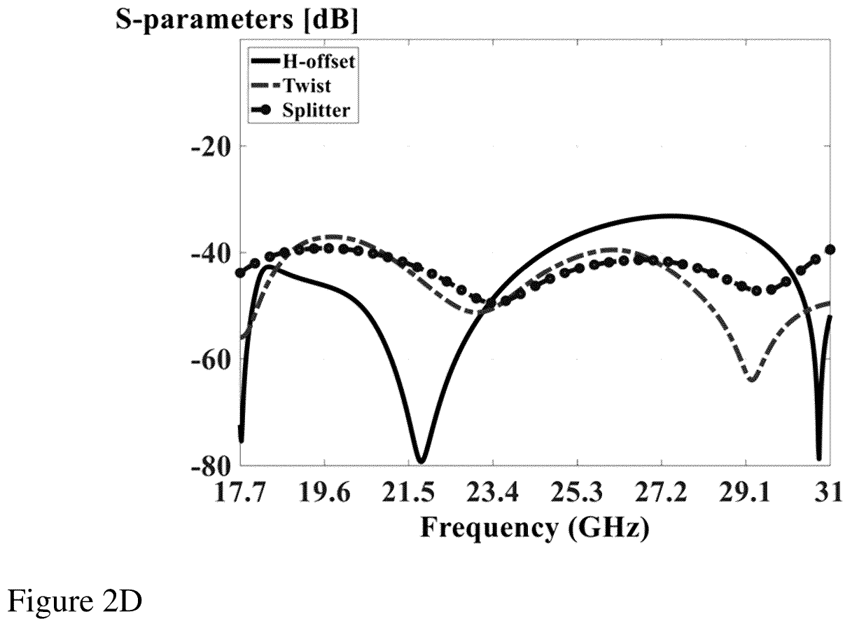

The design process is divided into two primary stages. In the first stage, each component is individually designed and optimized to enhance its performance as shown in FIGS. 2A to 2C which depict the H-offset, twists and E-splitter/combiner respectively where the H-offset and L_twist are 20 mm (˜0.49″) and 23 mm (˜0.90″) respectively. Subsequently, pairs of these optimized components are constructed and further optimized to achieve an improved overall response. FIG. 2D depicts modelled S-parameters of the H-offset, twist and splitter components depicted in FIGS. 2A to 2C respectively.

### 1C. Overall Assembly

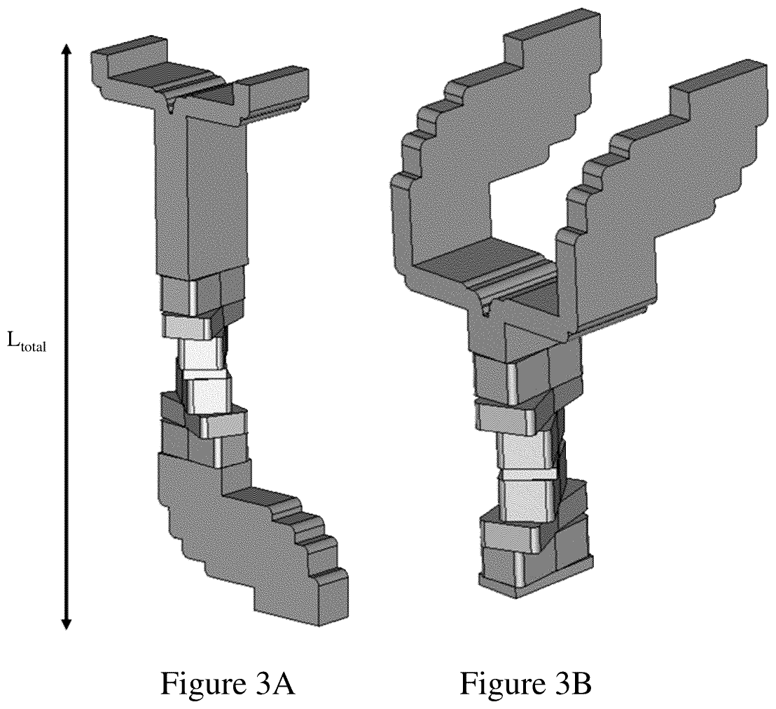

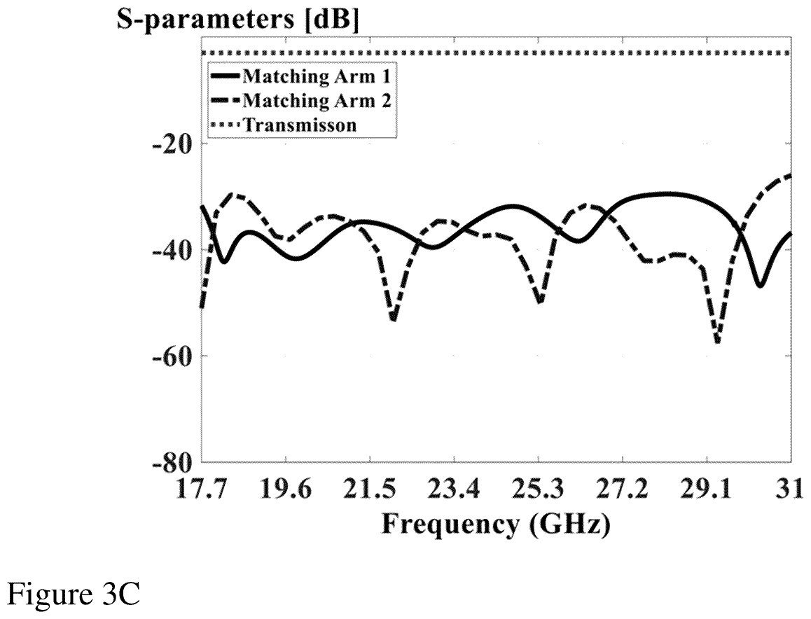

The E-splitter/combiner is optimized in conjunction with the twist, and subsequently, the entire structure is assembled with the H-offset. To ensure that there is no phase difference between the two paths, the optimized dimensions of the first arm are applied to the second arm. The primary distinction between the two arms lies in the presence of twists, as outlined above. However, the phase difference between the two paths was found to be negligible. The total length of the two assembled arms of the exemplary Ka-band design is 58.5 mm (˜ ″). FIGS. 3A and 3B depict the designs of the first and second arms of the combining network. As evident from the simulated S-parameters in FIG. 3C the first and second arms achieve a matching level of approximately 30 dB over the entire bandwidth from 17.7 GHZ to 31 GHZ.

### 2. Results and Discussion

In the following section the results of a comprehensive study are presented to demonstrate the feasibility of the overall design for satellite applications. This study was carried out from three perspectives, the first one is studying the electrical responses. Afterward, thermal response and gas breakdown results are presented and discussed to ensure compliance with the specifications for LEO satellite feeding structures. Mechanical modeling was carried out and pressure calculations were performed using SolidWorks™. The pressure test was carried out to ensure good contact between each part, so required the level of passive intermodulation can be achieved.

### 2A. Electrical Response

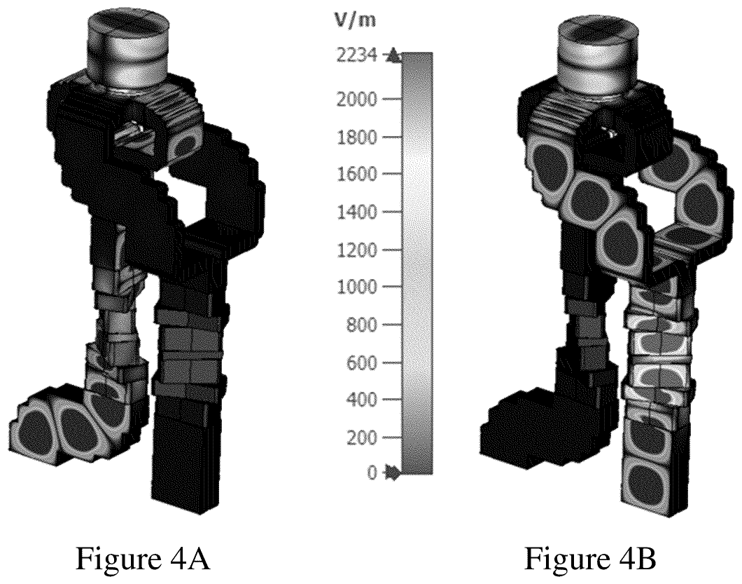

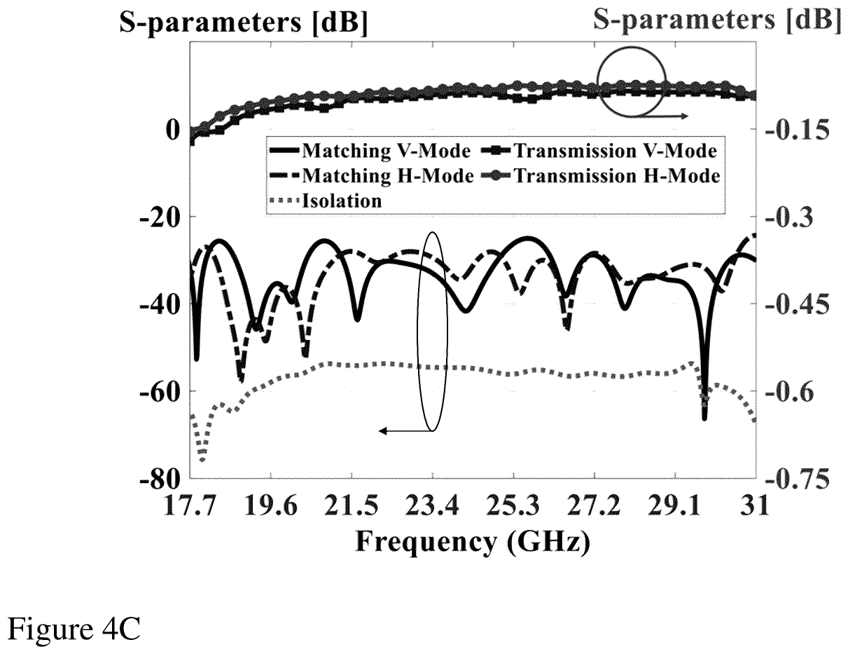

The OMT main section comprising the circular input, turnstile junction polarizer, and four rectangular ports, see FIGS. 1A-ID, was combined with the H-offset, twists and E-splitter/combiner depicted in FIGS. 2A to 2C respectively, and the first and second arms depicted in FIGS. 3A and 3B respectively and a two-mode simulation was performed using CST Studio Suite™. The mode field lines of the V-mode and H-mode being depicted in FIGS. 4A and 4B whilst the simulated S-parameters of the matching V-mode, matching H-mode, transmission V-mode and transmission H-mode are depicted in FIG. 4C together with the simulated isolation between ports. The matching level for both modes is around 25 dB with an isolation level below 55 dB. Moreover, the insertion loss obtained for the simulated OMT formed from aluminum is below approximately 0.15 dB.

### 2B. Mechanical Model

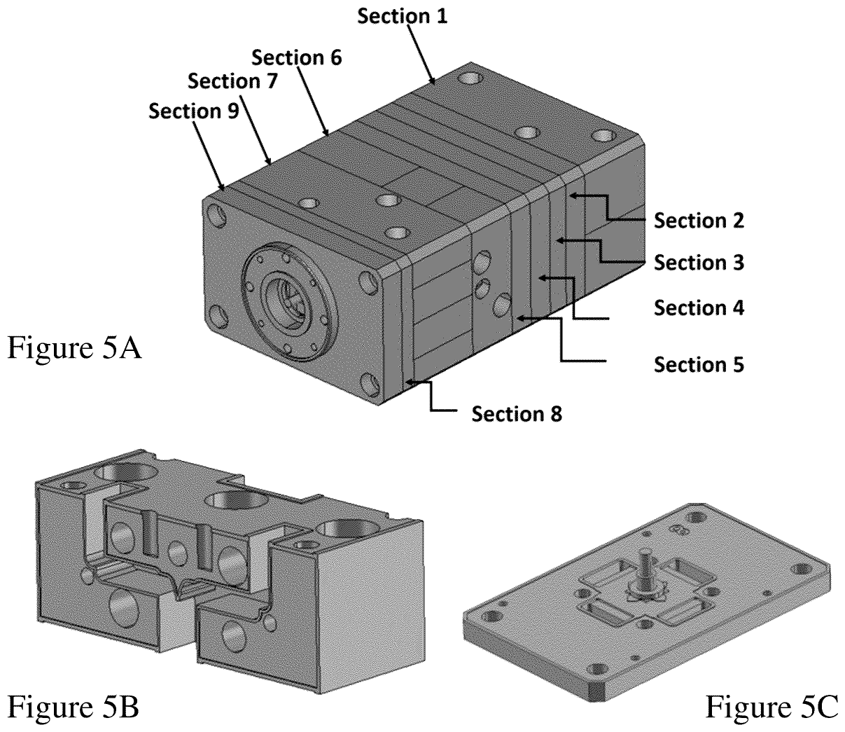

The overall assembly model of the inventive OMT consists of nine main parts as depicted in FIG. 5A, carefully designed to ensure proper electrical performance and facilitate the fabrication process. The structure depicted in FIG. 5A incorporates strategically placed cuts that do not compromise the electrical response of the OMT. Certain parts, such as sections 2, 3, 4, 5, 8, and 9, are composed of single sections without internal cuts. On the other hand, other parts feature internal cuts to achieve the desired configuration. These cut sections play a crucial role in the overall functionality and construction of the OMT, ensuring efficient operation and streamlined fabrication.

### 2C Power Assessment and Thermal Analysis

The inventors employed Spark3D, an advanced simulation tool specifically designed for accurately assessing the RF breakdown power level in various passive devices, including cavities, waveguides, microstrip, and antennas. It offers the capability to import electromagnetic field data from CST Studio Suite™, allowing for a comprehensive analysis of vacuum breakdown (multipactor) and gas discharge (corona). With Spark3D, it becomes possible to precisely determine a maximum power threshold that a device can withstand without experiencing RF breakdown.

This tool has been extensively utilized in numerous publications, serving as a basis for comparing proposed multipactor algorithms with the commercial Spark3D software. Furthermore, it has been relied upon as a reference for calculating vacuum breakdown and gas discharge without the need for laboratory measurements or experimental validations. The accuracy or Spark3D has been validated through comparisons With experimental verifications. demonstrating within a margin of approximately 0.5 dB when comparing simulation results with test data.

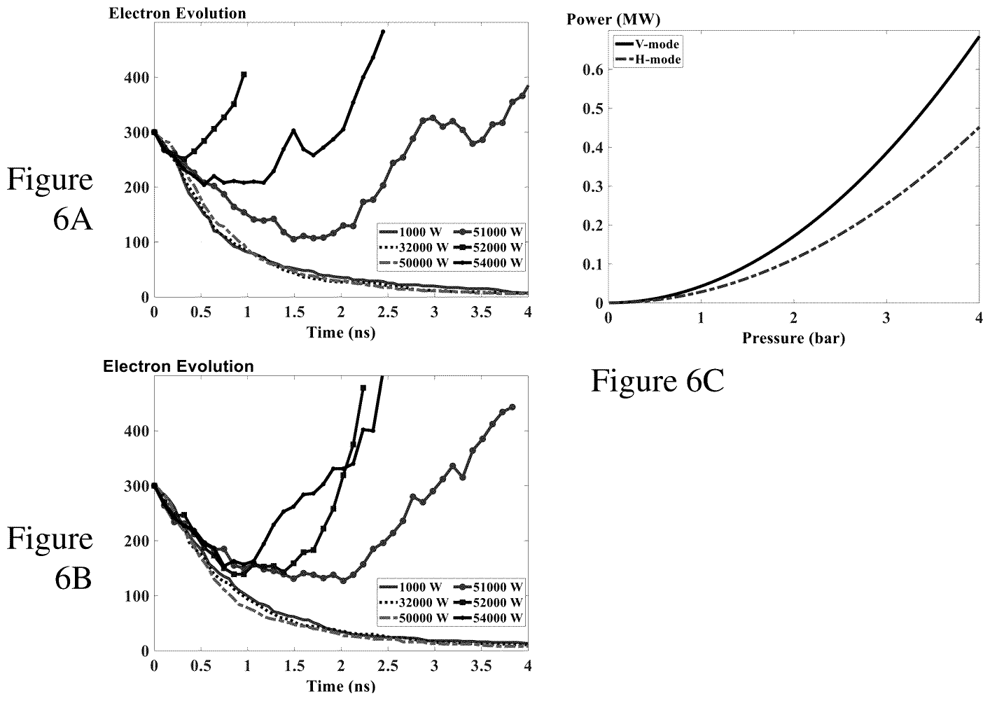

With the inventive OMT, the inventors studied the multipactor effect for both modes using the SPARK 3D tool. The multipaction analysis for the V-mode and H-mode are depicted in FIGS. 6A and 6B respectively. The corona analysis results are depicted in FIG. 6C. From this analysis the breakdown power is approximately 50 k Watt for both modes. Moreover, a thermal analysis was conducted to investigate the influence of input power and ambient temperature on the OMT's performance. The thermal and mechanical analysis was performed using CST Studio Suite™, for an input power of 500 W with varying ambient temperatures ranging from −65° C. to +130° C. The inventive OMT was modelled for the influence of temperature as this impacts on its dimensional stability. As the temperature is increased +130° C., the overall structure experiences a slight expansion, leading to a dimensional increase of approximately 0.10 mm (˜0.004″). Conversely, in colder environments with a temperature of −65° C., the structure undergoes a slight contraction, resulting in a dimensional decrease of about 0.076 mm (˜0.003″).

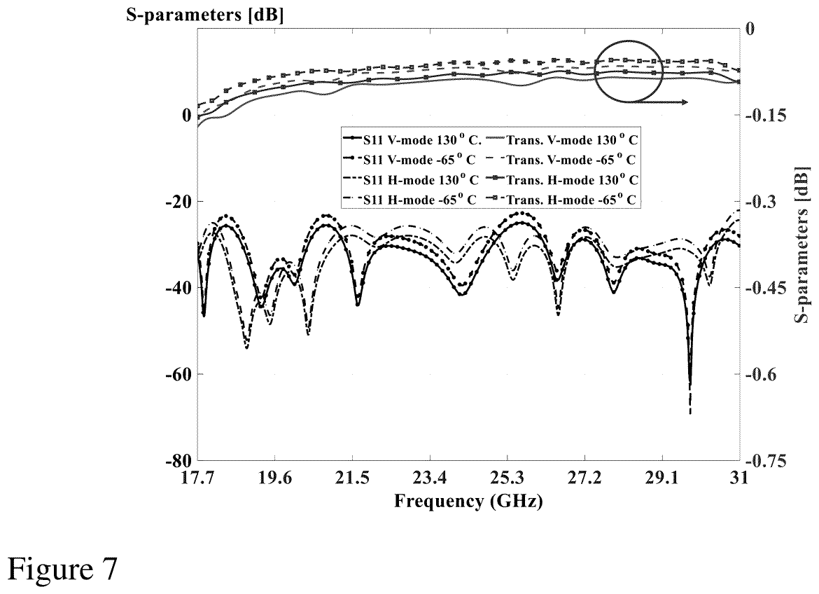

The resulting simulation results are depicted in FIG. 7 where it is evident that the temperature variations have minimal impact upon the electrical response of the OMT. The matching level is changed by approximately 1 dB, whilst the insertion loss only changed by 0.04 dB, as evident in FIG. 7. These previous studies and results are performed on the mechanical model depicted in FIG. 5.

### 2D. Passive Intermodulation Analysis

Passive Intermodulation (PIM) refers to the generation of intermodulation products when multiple signals pass through a passive device with nonlinear characteristics. These nonlinear elements are often attributed to the interaction of mechanical components, particularly at junctions involving dissimilar metals, for example. In order to satisfy PIM requirements, the pressure between each section/subsection should be around (1 MPa). The design modelled employed screws for all intermediate flanges to ensure a strong connection, resulting in high pressure on connection surfaces. Custom-designed flange patterns were employed to achieve the necessary surface compression. Further, a cavity is incorporated to enhance compression beneath the head of the screw.

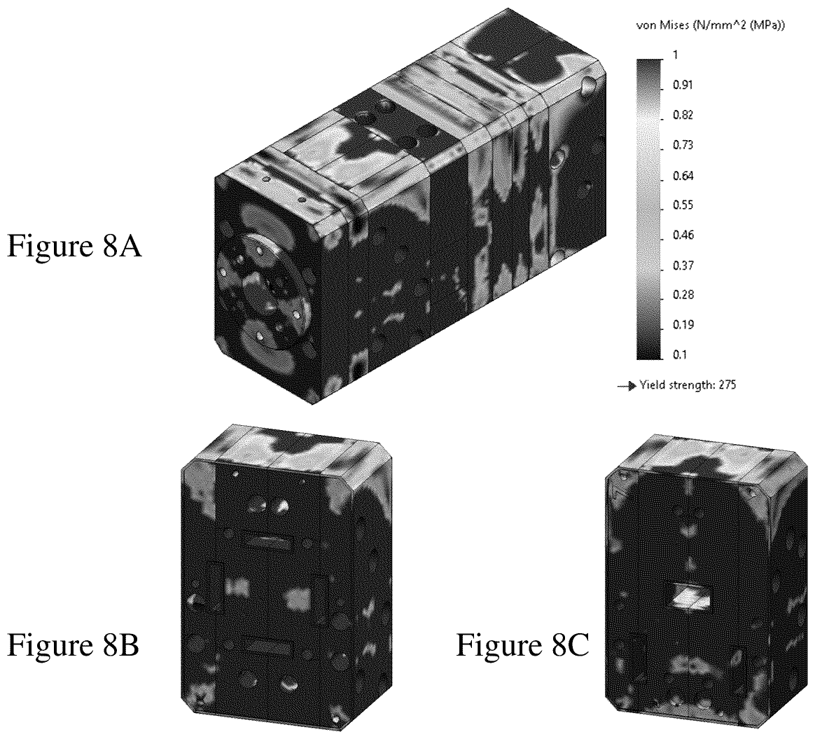

A simulation for the pressure calculation was carried out using SolidWorks™ for three different temperatures (−65° C., +25° C., and +130° C.). The resultant pressure between each layer is around I MPa as depicted in FIGS. 8A to 8C respectively. The straight lines in the structure depicted in FIG. 8A represent the external features, addressing the mechanical considerations. Further, the internal structure attains a pressure of 1 MPa, as indicated in FIGS. 8B and 8C which depict internal cuts for sections 7 and 5 respectively.

### 3. Experimental Verification

In order to test the inventive OMT, a complete waveguide setup was fabricated, which is composed of:
Two end launch waveguide adapters;
Two rectangular waveguide matching loads;
Custom throughs in the calibration process;
Circular waveguide matching load; and
Two transitions from rectangular to circular waveguide.

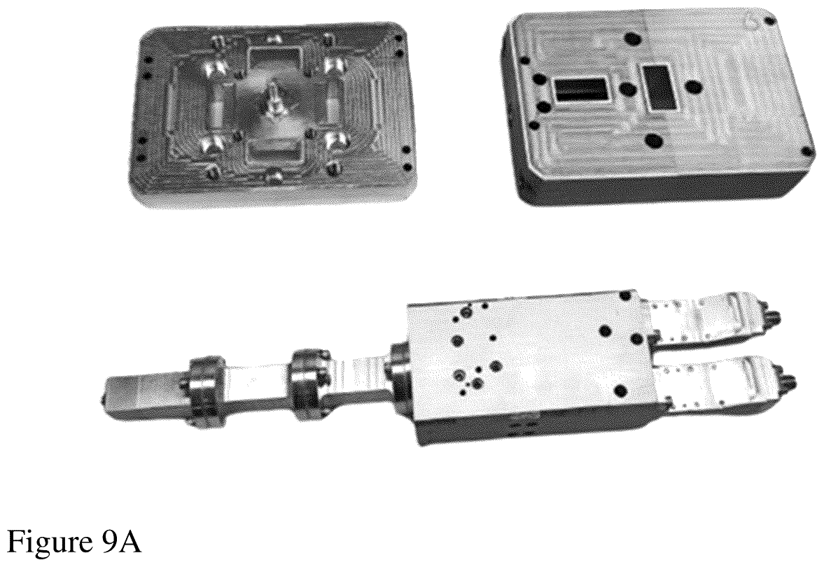

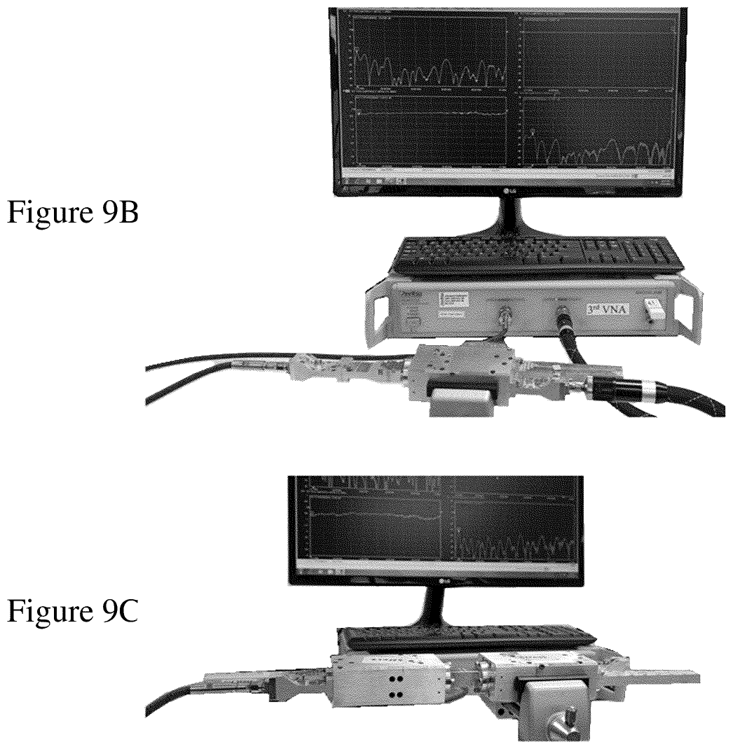

Fabrication was executed with a computer numerical control milling machine, ensuring an accuracy of +0.5 mil. The measurement set-up utilizes a vector network analyser (VNA) with a waveguide triple offset short calibration. The system evaluation employed two proposed techniques as discussed in the following sections. The fabricated parts being depicted in FIG. 9A.

### 3A. Single Unit Evaluation

This measurement involves a single fabricated OMT unit with circular load termination to determine the return loss of the rectangular ports. The back-to-back measurements of the rectangular-to-circular transitions were then utilized to assess the insertion loss of the OMT. Aligning the transition to the circular port allows for the measurement of the insertion loss for the first two modes. Rotating the circular transition by 90 degrees facilitates the measurement of the insertion loss for the other mode. The transition back-to-back registers approximately 0.25 dB, while the measured insertion loss for the OMT was approximately 0.53 dB. This being depicted in FIG. 9B.

### 3B. Back-to-Back Evaluation

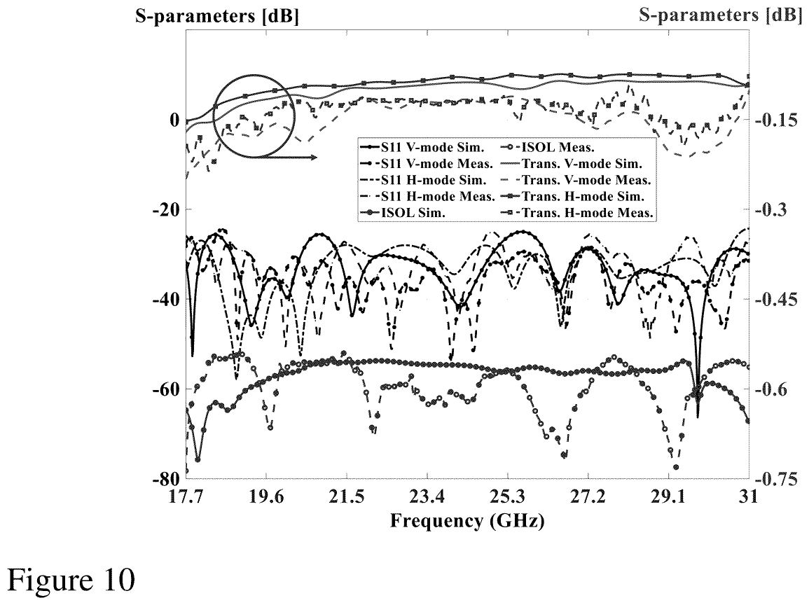

Another OMT was manufactured and assembled, as depicted in FIG. 9C. A back-to-back measurement was conducted to independently verify the evaluation of a single unit. The resulting return loss for both modes is approximately 21 dB, with an insertion loss of approximately 0.4 dB. This shows good agreement for the insertion loss calculations obtained from the previous measurement. The overall performance of the measured OMT is compared to the simulated results in FIG. 10. A notable agreement is observed between the measured and simulated outcomes regarding return loss and isolation. However. the insertion loss for the fabricated unit is marginally higher by approximately 0.05 dB compared to the simulated value. 3C. Comparison to Prior Art

The inventive OMT was compared with other published twofold OMT structures that operate in the frequency range from 10-110 GHz as presented within Table 2.

TABLE 2
Comparison of Inventive OMT with Prior Art Twofold OMTs

| | | | Return | Insertion | | |
|---|---|---|---|---|---|---|
| | Frequency | Bandwidth | Loss | Loss | Isolation | Size |
| Design | (GHz) | (%) | (dB0 | (dB) | (dB) | (λ_{O}³) |
| A | 7.5-12 | 46.15 | 19 | 0.15 | −40 | — |
| B | 8.2-12.4 | 40.70 | 18.5 | 0.15 | −40 | 5.05 × 5.05 × 5.3 |
| C | 18-26 | 36.36 | 19 | 0.15 | −48 | 10.78 × 10.78 × 7.04 |
| D | 24-42 | 54.54 | 20 | — | −60 | — |
| E | 29-50 | 53.00 | 20 | 1.5 | −60 | 12.11 × 11.58 × 4.5 |
| F | 30-+44 | 37.80 | 25 | — | −50 | — |
| G | 67-116 | 53.00 | 20 | 0.60 | −60 | 18 × 19 × 7.6 |
| H | 75-110 | 37.80 | 20 | 0.35 | −40 | — |
| Inventive | 17.7-31 | 54.60 | 25 | 0.20 | −50 | 4 × 2.2 × 5.3 |
| Design | | | | | | |

A: Srikanth et al. “A compact full waveguide band turnstile junction orthomode transducer,” 2011 URSI General Assembly and Scientific Symp., Istanbul, Turkey, pp. 1-4, 20 Oct. 2011.
B: Park et al. “A turnstile junction waveguide orthomode transducer for the simultaneous dual polarization radar,” 2009 Asia Pacific Microw. Conf., Singapore, pp. 135-138, 7 Dec. 2009.
C: Navarrini et al. “A turnstile junction waveguide orthomode transducer”. IEEE Trans. on Microw. Theory and Techn., vol. 54, no. 1, pp. 272-277, 10.January 2006
D: Xiao et al. “A Dual-Polarized Horn Antenna Covering Full Ka-Band Using Turnstile OMT”. Frontiers in Physics. Vol. 10, 5 Apr. 2022.
E: Chiong et al. “Cryogenic 29-50 GHz Orthomode Transducer for Radio Astronomical Receiver,” 2018 Asia-Pacific Microw. Conf. (APMC), Kyoto, Japan, pp. 1271-1273, 6 Nov. 2018.
F: Dousset et al. “A Compact High-Performance Orthomode Transducer for the Atacama Large Millimeter Array (ALMA) Band 1 (31-45 GHZ),” in IEEE Access, vol. 1, pp. 480-487, 8, July 2013.
G: Barructo et al. “A broadband Orthomode Transducer for the new ALMA band 2+3 (67-116 GHZ),” 2016 Global Symp. on Millimeter Waves (GSMM) & ESA Workshop on Millimetre-Wave Technology and Applications, Espoo, Finland, pp. 1-4; 8 Jun. 2016.
H: Pisano et al., “A Broadband WR10 Turnstile Junction Orthomode Transducer,” IEEE Microw. and Wireless Components Lett., vol. 17, no. 4, pp. 286-288, 7 Apr. 2007

Accordingly, it is evident that the overall size of the inventive OMT is substantially lower than that of the prior art designs. The overall OMT size is a significant drawback for the prior art designs with respect to satellite deployments or other deployments where space is a ta premium.

Further, the ports in the overall structure of the prior art designs, unlike the inventive design, are not aligned to be on the same orientation. Non-alignment of the ports presents, in addition to the volume of the OMTs themselves, challenges when integrating the OMT with other devices. Furthermore, some of the prior art OMT designs have ports that are not even located in the same plane, see Park et al., Dousset et al. and Pisano et al.

Accordingly, the inventive OMT design demonstrates a wideband operation with a significant matching level of approximately 25 dB, whilst the structure also incorporates twists that enable the alignment of the ports, ensuring they have the same orientation within the same plane. Furthermore, the overall OMT is almost compact. These are significant advantages of the inventive OMT design over the prior art in ensuring compliance with the LEO satellite feeding structure.

Specific details are given in the above description to provide a thorough understanding of the embodiments. However, it is understood that the embodiments may be practiced without these specific details. For example, circuits may be shown in block diagrams in order not to obscure the embodiments in unnecessary detail. In other instances, well-known circuits, processes, algorithms, structures, and techniques may be shown without unnecessary detail in order to avoid obscuring the embodiments.

The foregoing disclosure of the exemplary embodiments of the present invention has been presented for purposes of illustration and description. It is not intended to be exhaustive or to limit the invention to the precise forms disclosed. Many variations and modifications of the embodiments described herein will be apparent to one of ordinary skill in the art in light of the above disclosure. The scope of the invention is to be defined only by the claims appended hereto, and by their equivalents.

Further, in describing representative embodiments of the present invention, the specification may have presented the method and/or process of the present invention as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the claims. In addition, the claims directed to the method and/or process of the present invention should not be limited to the performance of their steps in the order written, and one skilled in the art can readily appreciate that the sequences may be varied and still remain within the spirit and scope of the present invention.

What is claimed is:

1. A device comprising:
a first element comprising an input port, a junction and four output ports in a plane wherein a microwave signal within a predetermined frequency range coupled to the input port is split into a first polarisation which is coupled to a first pair of the four output ports which are disposed on either side of junction along a first axis and a second polarisation which is coupled to a second pair of the four output ports which are disposed on either side of junction along a second axis where the first axis is orthogonal to the second axis;
a first arm of a combining network comprising;
a first combiner comprising a pair of first ports coupled to one of the first pair of the four output ports and the second pair of the four output ports and a second port coupled to the pair of first ports;
a waveguide twist coupled at one end to the second port of the first combiner and at a second distal end to a first offset waveguide; and
the first offset waveguide; and
a second arm of the combining network comprising:
a second combiner comprising another pair of first ports coupled to the other of the first pair of the four output ports and the second pair of the four output ports and another second port coupled to the pair of first ports where the each first port of the another pair of first ports is coupled to an output port of the other of the first pair of the four output ports and the second pair of four output ports by a second offset waveguide;
the two second offset waveguides; and
another waveguide twist coupled at one end to the another second port of the second combiner and at a second distal end of the another waveguide twist to an end of a waveguide.

2. The device according to claim 1, wherein
the junction is a turnstile junction comprising a series of stepped cylinders;
an upper stepped cylinder of the series of stepped cylinders is disposed towards the input port;
the series of stepped cylinders have increasing diameters from the upper stepped cylinder of the series of stepped cylinders and are disposed along an axis away from the input port.

3. The device according to claim 1, wherein
each output port of the four output ports is a half-height rectangular waveguide.

4. The device according to claim 1, wherein
the distal end of the waveguide and a distal end of the first offset waveguide are aligned along a common plane.

5. The device according to claim 1, wherein
each output port of the four output ports is a half-height rectangular waveguide;
the pair of first ports of the first combiner, the two second offset waveguides and the another pair of first ports of the second combiner are half-height rectangular waveguides;
the second port of the first combiner and the another second port of the second combiner are a full-height rectangular waveguides; and
the waveguide twist, the another waveguide twist and the first offset waveguide are full-height rectangular waveguides.

6. The device according to claim 1, wherein
each output port of the four output ports is a half-height rectangular waveguide;
the pair of first ports of the first combiner, the two second offset waveguides and the another pair of first ports of the second combiner are half-height rectangular waveguides;
the second port of the first combiner and the another second port of the second combiner are a full-height rectangular waveguides;
the waveguide twist, the another waveguide twist and the first offset waveguide are full-height rectangular waveguides; and
the full-height rectangular waveguide of the distal end of the waveguide and the full-height rectangular waveguide at a distal end of the first offset waveguide are aligned along a common plane.

7. The device according to claim 1, wherein
the junction is a turnstile junction comprising a series of stepped cylinders;
an upper stepped cylinder of the series of stepped cylinders is disposed towards the input port;
the series of stepped cylinders have increasing diameters from the upper stepped cylinder of the series of stepped cylinders and are disposed along an axis away from the input port;
each output port of the four output ports is a half-height rectangular waveguide;
the pair of first ports of the first combiner, the two second offset waveguides and the another pair of first ports of the second combiner are half-height rectangular waveguides;
the second port of the first combiner and the another second port of the second combiner are a full-height rectangular waveguides;
the waveguide twist, the another waveguide twist and the first offset waveguide are full-height rectangular waveguides; and
the full-height rectangular waveguide of the distal end of the waveguide and the full-height rectangular waveguide at a distal end of the first offset waveguide are aligned along a common plane.

8. A method comprising:
providing a first element comprising an input port, a junction and four output ports in a plane wherein a microwave signal within a predetermined frequency range coupled to the input port is split into a first polarisation which is coupled to a first pair of the four output ports which are disposed on either side of junction along a first axis and a second polarisation which is coupled to a second pair of the four output ports which are disposed on either side of junction along a second axis where the first axis is orthogonal to the second axis;
providing a first arm of a combining network comprising;
a first combiner comprising a pair of first ports coupled to one of the first pair of the four output ports and the second pair of the four output ports and a second port coupled to the pair of first ports;
a waveguide twist coupled at one end to the second port of the first combiner and at a second distal end to a first offset waveguide; and
the first offset waveguide; and
providing a second arm of the combining network comprising:
a second combiner comprising another pair of first ports coupled to the other of the first pair of the four output ports and the second pair of the four output ports and another second port coupled to the pair of first ports where the each first port of the another pair of first ports is coupled to an output port of the other of the first pair of the four output ports and the second pair of four output ports by a second offset waveguide;
the two second offset waveguides; and
another waveguide twist coupled at one end to the another second port of the second combiner and at a second distal end of the another waveguide twist to an end of a waveguide.

9. The method according to claim 8, wherein
the junction is a turnstile junction comprising a series of stepped cylinders;
an upper stepped cylinder of the series of stepped cylinders is disposed towards the input port;
the series of stepped cylinders have increasing diameters from the upper stepped cylinder of the series of stepped cylinders and are disposed along an axis away from the input port.

10. The method according to claim 8, wherein
each output port of the four output ports is a half-height rectangular waveguide.

11. The method according to claim 8, wherein
the distal end of the waveguide and a distal end of the first offset waveguide are aligned along a common plane.

12. The method according to claim 8, wherein
each output port of the four output ports is a half-height rectangular waveguide;
the pair of first ports of the first combiner, the two second offset waveguides and the another pair of first ports of the second combiner are half-height rectangular waveguides;
the second port of the first combiner and the another second port of the second combiner are a full-height rectangular waveguides; and
the waveguide twist, the another waveguide twist and the first offset waveguide are full-height rectangular waveguides.

13. The method according to claim 8, wherein
each output port of the four output ports is a half-height rectangular waveguide;
the pair of first ports of the first combiner, the two second offset waveguides and the another pair of first ports of the second combiner are half-height rectangular waveguides;
the second port of the first combiner and the another second port of the second combiner are a full-height rectangular waveguides;
the waveguide twist, the another waveguide twist and the first offset waveguide are full-height rectangular waveguides; and
the full-height rectangular waveguide of the distal end of the waveguide and the full-height rectangular waveguide at a distal end of the first offset waveguide are aligned along a common plane.

14. The method according to claim 8, wherein
the junction is a turnstile junction comprising a series of stepped cylinders;
an upper stepped cylinder of the series of stepped cylinders is disposed towards the input port;
the series of stepped cylinders have increasing diameters from the upper stepped cylinder of the series of stepped cylinders and are disposed along an axis away from the input port;
each output port of the four output ports is a half-height rectangular waveguide;
the pair of first ports of the first combiner, the two second offset waveguides and the another pair of first ports of the second combiner are half-height rectangular waveguides;
the second port of the first combiner and the another second port of the second combiner are a full-height rectangular waveguides;
the waveguide twist, the another waveguide twist and the first offset waveguide are full-height rectangular waveguides; and
the full-height rectangular waveguide of the distal end of the waveguide and the full-height rectangular waveguide at a distal end of the first offset waveguide are aligned along a common plane.
